(19) United States
(12) Patent Application Publication
(10) Pub. No.: US 2018/0075852 A1
(43) Pub. Date: Mar. 15, 2018

(54) METHOD AND APPARATUS FOR EMBEDDING AND REGAINING WATERMARKS IN AN AMBISONICS REPRESENTATION OF A SOUND FIELD

(71) Applicant: THOMSON Licensing, Issy-les-Moulineaux (FR)

(72) Inventors: Xiaoming CHEN, HANNOVER (DE); Ulrich GRIES, HANNOVER (DE); Peter Georg BAUM, HANNOVER (DE); Michael ARNOLD, ISEMHAGEN (DE)

(21) Appl. No.: 15/561,065

(22) PCT Filed: Feb. 18, 2016
(86) PCT No.: PCT/EP2016/053440

§ 371 Date: Sep. 24, 2017

(30) Foreign Application Priority Data
Mar. 24, 2015 (EP) 15305427.5

(51) Int. Cl. G10L 19/018; H04S 3/00; G10L 19/008

(52) U.S. Cl. CPC G10L 19/018; H04S 2420/11; G10L 19/008; H04S 3/008

(57) ABSTRACT

As a potential format for next-generation audio, techniques for embedding digital watermarks in the Higher Order Ambisonics (HOA) representation of a sound field have been proposed. The inventive embedding method is adapted for watermarking a two-dimensional or three-dimensional Ambisonics representation of a sound field, wherein the Ambisonics representation is decomposed into directional signals and ambient components and includes estimated dominant directions, and wherein the order of the ambient components can be reduced, and wherein watermark information data are embedded in the directional signals, and at receiver side are regained from the watermarked directional signals.

### TECHNICAL FIELD

The invention relates to a method and to an apparatus for embedding and regaining watermarks in a two-dimensional or three-dimensional Ambisonics representation of a sound field.

### BACKGROUND

As a potential format for next-generation audio, techniques for embedding digital watermarks in the Higher Order Ambisonics (HOA) representation of a sound field have been proposed. In [7], watermarks are embedded either in synthesised/recorded audio signals or in the Ambisonics representation of a sound field. An additive watermarking is employed where the watermarked signal is composed of an original host signal and a weighted and directionally rotated version thereof. However, in the Ambisonics domain rotation has only been considered for the first order (B-format). Since rotation in HOA domain is also possible as shown in [8], the embedding via rotation can also be extended to the HOA format. However, different directions have different perceptual sensitivities against rotation. Therefore, in order to maintain perceptual fidelity, only very small rotations are allowed for Ambisonics signals.

For embedding directly in recorded/synthesised audio signals, different watermarks are embedded in individual audio signals. Both, source directions and directions after rotation have to be known for watermark detection (so-called semi-blind detection). The problem here is that a tuning process is necessary for individual source directions to perform a trade-off between perceptual quality and embedding strength by individually rotating different source directions. Embedding different watermarks into individual signals increases the data rate that can be transmitted. On the other hand, this embedding strategy may be not robust against HOA compression.

### SUMMARY OF INVENTION

An HOA compression is shown in WO2013/171083 A1 [9] in which the Ambisonics representation of a sound field is decomposed into directional signals and ambient components. Directional signals and their associated directions are transmitted, while only a reduced-order representation of ambient components is transmitted. Therefore some watermarks embedded in individual audio signals cannot be detected if they are embedded prior to compression, see [7]. This problem could be circumvented by embedding the same watermark in individual audio signals, which however would cause a reduction of the available data rate for the watermarking data channel.

A problem to be solved by the invention is to improve water-marking of a 2D or 3D Ambisonics sound field representation. This problem is solved by the embedding method disclosed in claim 1 and the regaining method disclosed in claim 8. Apparatus that utilise these methods are disclosed in claims 2 and 9.

Advantageous additional embodiments of the invention are disclosed in the respective dependent claims.

The following description discloses embedding and detecting of digital watermarks in a 2D or 3D Ambisonics representation of a sound field, based on the decomposition of the Ambisonics representation into dominant directional signals and ambient or residual components. The watermark data signal is embedded in the dominant directional signals by any PCM audio watermarking technique that operates in the baseband signal.

Watermark detection can be performed as a part of the Ambisonics decoding processing following digital transmission. Alternatively, watermark detection can be carried out after recording of the rendered sound field. If a spherical microphone is available, directional signals can be estimated again in order to improve the robustness of the embedded watermarks.

Advantageously, the embedding of watermark information in such directional signals provides a better trade-off between fidelity and robustness against HOA compression, because directional signals are perceptually dominant and a relatively high embedding strength can be used without degrading the resulting perceptual fidelity. In addition, since directional signals are delivered without any change after HOA compression, a high robustness of the embedded watermarks is ensured.

In principle, the inventive embedding method is adapted for watermarking a two-dimensional or three-dimensional Ambisonics representation of a sound field, wherein said Ambisonics representation is decomposed into directional signals and ambient components and includes estimated dominant directions, and wherein the order of said ambient components can be reduced, and wherein watermark information data are embedded in said directional signals.

In principle the inventive embedding apparatus is adapted for watermarking a two-dimensional or three-dimensional Ambisonics representation of a sound field, said apparatus being adapted to:
decomposing said Ambisonics representation into directional signals and ambient components and estimated dominant directions, wherein the order of said ambient components can be reduced;
embed watermark information data in said directional signals.

In principle, the inventive regaining method is adapted for regaining watermark information data which were embedded in a two-dimensional or three-dimensional Ambisonics representation of a sound field according to the above embedding method, including:
decomposing said watermarked Ambisonics representation into said directional signals, said estimated dominant directions and said ambient components;
performing a watermark detection in said watermarked directional signals.

In principle the inventive regaining apparatus is adapted for regaining watermark information data which were embedded in a two-dimensional or three-dimensional Ambisonics representation of a sound field according to the above embedding method, said apparatus being adapted to:
decompose said watermarked Ambisonics representation into said directional signals, said estimated dominant directions and said ambient components;
perform a watermark detection in said watermarked directional signals.

### BRIEF DESCRIPTION OF DRAWINGS

Exemplary embodiments of the invention are described with reference to the accompanying drawings, which show in:

FIG. 1 Spherical coordinate system with inclination angle θ and azimuth angle φ;

FIG. 2 Watermarking directional signals;

FIG. 3 Watermark embedder within an HOA encoder;

FIG. 4 Phase-based watermark embedding processing as disclosed in [1] specifically applied to HOA directional signals;

FIG. 5 Watermark embedder within the perceptual encoder in HOA;

FIG. 6 Watermark detection from watermarked ambisonics coefficients;

FIG. 7 Watermark detection within HOA decoding;

FIG. 8 Standalone watermark detection;

FIG. 9 Watermark detection following recording via a spherical microphone like Eigenmike;

FIG. 10 Phase-based watermark detection processing as disclosed in [1] specifically applied to watermarked HOA directional signals.

### DESCRIPTION OF EMBODIMENTS

Even if not explicitly described, the following embodiments may be employed in any combination or sub-combination.

Higher Order Ambisonics (HOA)

Ambisonics employ truncated spherical harmonic expansion (up to an order N in equation (1)) for representing a sound field:

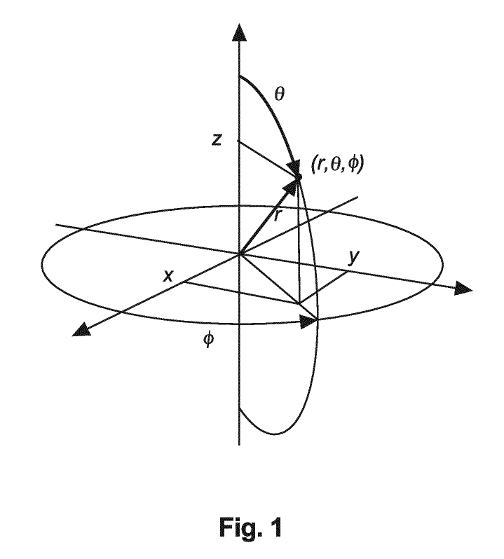

X(kr;θ,φ)=Σₙ₌₀^{N}Σₘ₌₋ₙⁿAₙ^{m}(kr)Yₙ^{m}(θ,φ), (1)

where X(kr;θ,φ) denotes the pressure on a sphere for an arbitrary direction (θ,φ). FIG. 1 depicts a spherical coordinate system with inclination angle θ and azimuth angle φ, and r is the distance from the listening point as origin (sweet spot) of the coordinate system.

The angular wave number is denoted by

$$k = \frac{2 π f}{c} = \frac{2 π}{λ}$$

with f and λ denoting frequency and wavelength, respectively. Spherical harmonics (SH) are denoted by {Yₙ^{m}(θ, φ)}, and {Aₙ^{m}(kr)} are the expansion (ambisonics) coefficients. The trade-off between complexity and spatial resolution of representing a sound field via SH expansion is controlled by the expansion order N. In three-dimensional cases, there are 0=(N+1)² expansion coefficients, whereas in two-dimensional cases, i.e. θ≡0, there are 2N+1 coefficients. HOA refers to SH expansions with an order N>1. Accordingly, expansion coefficients are referred to as HOA coefficients, and the expansion order is also called HOA order. Instead of directly transmitting recorded or synthesised audio signals and their associated positions, SH expansion coefficients {Aₙ^{m}(kr)} are delivered for rendering in the context of Ambisonics. Given HOA coefficients and a specific loudspeaker setup, a renderer tries to reproduce the delivered sound field by loudspeakers. In other words, the flexibility of HOA—that it can be applied for different loudspeaker setups—comes at the expense that decoding is necessary for individual loudspeaker setups. Further details on HOA and decoding for HOA can be found in WO2011/117399 A1 [10] or in [3].

HOA compression via de-composition of HOA coefficients The data rate for transmitting HOA coefficients without compression can be evaluated as 0·fₛ·b bits/s, where 0 is the number of HOA coefficients (see above) for each time index, fₛ is the sampling frequency and b is the number of bits representing each HOA coefficient. HOA compression intends to reduce the data rate without sacrificing perceptual fidelity.

[9] shows how to reduce the data rate of transmitted HOA coefficients for the purpose of compression. The essential assumption is that HOA coefficients representing a sound field can be decomposed into directional signals and residual ambient components, and it has been verified that a lower HOA order, say Nₐ<N, is sufficient for representing the residual or ambient components. If there are D directional signals and Nₐ is employed to represent ambient components, the resulting data rate is ((Nₐ+1))²+D)·fₛ·b bits/s. Consequently, compression gain due to HOA coefficients' decomposition and representing ambient components via a lower HOA order is

$$\frac{O}{{O}_{a} + D} , {O}_{a} {=}^{Δ} {( {N}_{a} + 1 )}^{2} ,$$

which can be adjusted by varying the Nₐ and D parameters.

Because direction information of directional signals needs to be transmitted, this is an approximated compression gain. Typically the parameter D is pre-defined.

Embedding Watermark in Directional Signals

The watermark information data are embedded in the directional signals, irrespective of the Ambisonics order and irrespective of two-dimensional or three-dimensional Ambisonics.

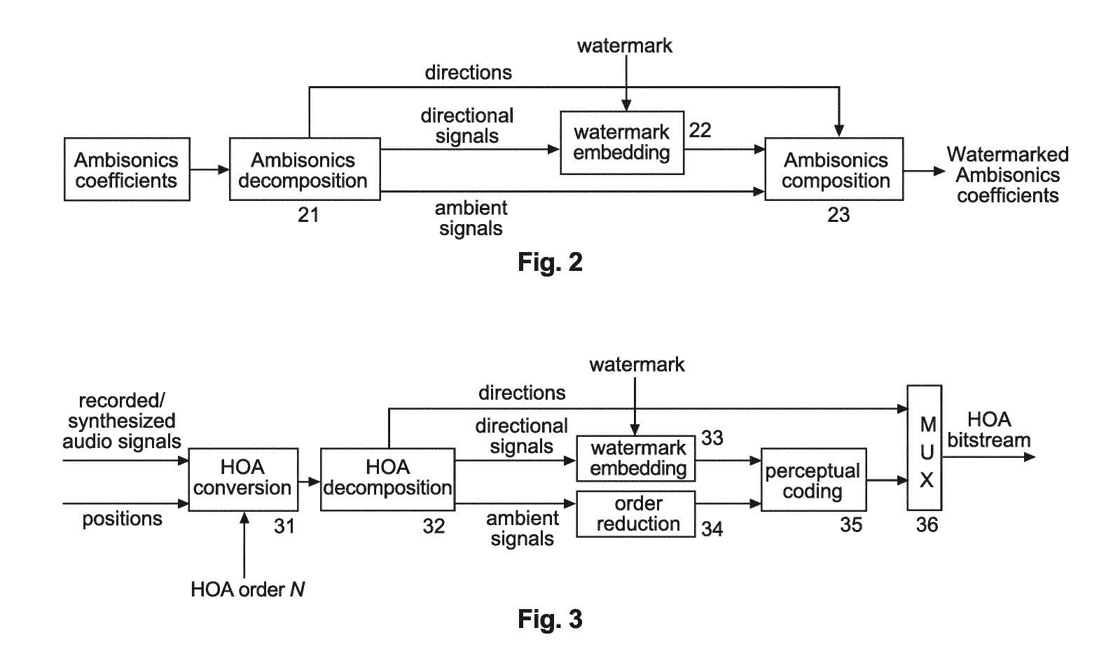

FIG. 2 illustrates watermark embedding by modifying Ambisonics coefficients which are calculated from recorded or synthesised audio signals or are extracted from an Ambisonics audio file in any known Ambisonics format, see [4]. Ambisonics coefficients are decomposed in step or stage 21 into estimated directional signals and corresponding estimated dominant directions information data, and residual ambient components or signals. One possible decomposition for HOA coefficients is disclosed in [9], which is also applicable for first-order Ambisonics. Directional signals can be interpreted as multiple PCM signals. Therefore, directional signals can be employed for arbitrary PCM audio watermarking techniques (see for example [1]). For each directional signal to be watermarked an individual masking curve can be used to constrain the watermark embedding strength.

In watermark embedding step or stage 22 one or more watermarks are embedded into one or more directional signals. The watermarked directional signals, the ambient signals and the direction information data are composed in Ambisonics composition step or stage 23, resulting in watermarked Ambisonics coefficients.

Watermarked directional signals and their associated estimated dominant directions are used to evaluate the corresponding Ambisonics representation, which is used for composing the final Ambisonics representation with residual ambient components obtained during decomposition. A similar composition process is described in [9] in the context of HOA decompression. Consequently, modified Ambisonics coefficients with watermark signals embedded can be used for a processing like compression as shown in [9] or in [11].

FIG. 3 illustrates how to perform watermark embedding within the framework of HOA compression. This processing can also be applied for first-order Ambisonics, but HOA has potentially wider applications than first-order Ambisonics. The HOA conversion step or stage 31 calculates HOA coefficients from received recorded or synthesised audio signals, together with corresponding position information items, and based on HOA order N. Following HOA conversion, the HOA coefficients are decomposed in step or stage 32 into directional signals and ambient signals or components and related estimated dominant direction information data, as shown in [9].

Watermarking is carried out in step or stage 33 for the directional signals with any PCM audio watermarking technique (see for example [1]). For each directional signal to be watermarked an individual masking curve can be used to constrain the watermark embedding strength. The ambient signals pass through an order reduction step or stage 34. The watermarked directional signals, together with the ambient HOA components after order reduction, are further compressed by means of perceptual coding in step or stage 35. Examples for such perceptual coding are AAC, mp3, or USAC (Unified speech and audio coding).

The direction information of corresponding signals is multiplexed in step/stage 36 with the perceptually coded bitstream so as to form a watermarked HOA bitstream.

Since there are D directional signals, different watermark signals can be embedded in individual directional signals in order to achieve a high data rate for watermark transmission. Alternatively, if so desired, the same watermark signal can be embedded in individual directional signals for high robustness against potential signal processing and acoustic path transmission. Moreover, spread spectrum techniques and error correction codes can be employed for further increase of robustness, see [1].

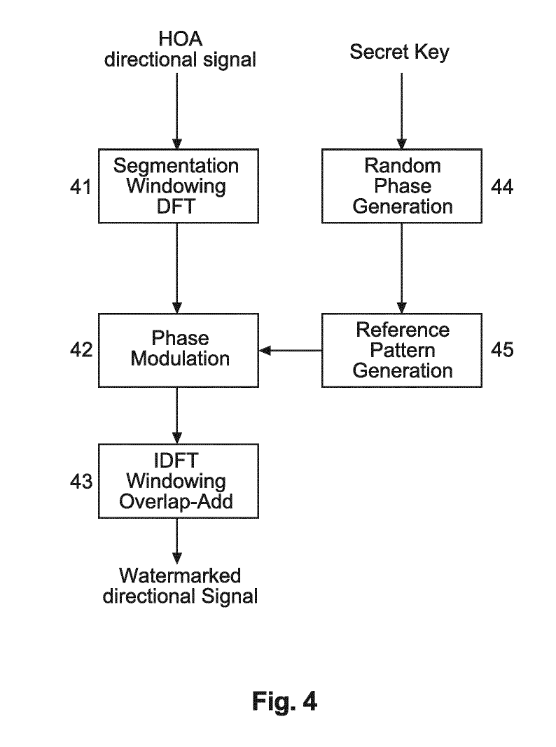

FIG. 4 shows an example for watermark embedding using audio signal phase modifications as disclosed in [1]. A directional signal passes through a step or stage 41 for segmentation, windowing and DFT to a phase modulation step or stage 42. Based on a secret key and a related watermark symbol alphabet size, the secret key is used for a random phase generation step or stage 44 and a corresponding generation of reference patterns of e.g. 16384 samples length in step or stage 45. Dependent on the watermark symbol to be embedded, a reference pattern is selected for modifying in step/stage 42 phases of one directional signal after HOA decomposition. For each directional signal to be watermarked an individual masking curve can be used to constrain the watermark embedding strength. Thereby, the masking curve of the directional signal is determined so that the phase modification will not cause any perceptual degradation. A following IDFT, windowing and overlap-add step or stage 43 outputs the watermarked directional signal. Watermarked directional signals are processed to re-compose HOA coefficients as in FIG. 2 or to obtain the final HOA bitstream, see FIG. 3.

A watermark payload can be protected by error correction. Each watermark symbol corresponds to a reference pattern 45 in the watermark information data embedding 42.

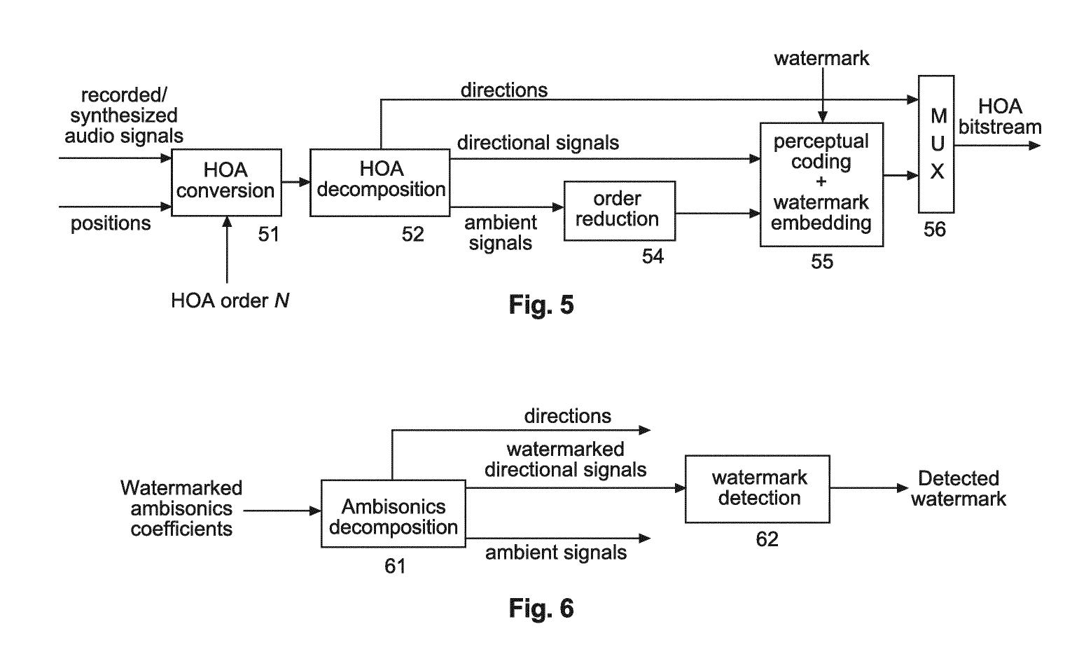

The robustness of the embedded watermarks and the quality of the watermarked directional signals is changed by the successive perceptual coder. Therefore another possibility to better control the trade-off between watermark robustness, compression and quality, the watermark embedding step can also be integrated directly in the perceptual coder, as depicted in FIG. 5. Recorded or synthesised audio signals, data about positions and the value N of the HOA order are supplied to an HOA converter 51. The HOA representation signal is fed to a HOA decomposition step or stage 52, which outputs directional signal data, related estimated dominant direction data, and ambient signal data. Preferably the order of the ambient signal is reduced in order reduction step or stage 54. The directional signal data and the order-reduced ambient signal data are perceptually encoded in step or stage 55, whereby watermark data are embedded. Examples for audio watermarking for AAC and AC-3 can be found in [6] and in [5], respectively. The perceptually encoded directional signal data and order-reduced ambient signal data together with the direction data are multiplexed in a multiplexer step or stage 56, which outputs a watermarked HOA bitstream.

Watermark Detection

If, possibly after different signal processing procedures, watermarked Ambisonics coefficients are available, which can be extracted from an Ambisonics audio file or which are converted from audio signals recorded by a spherical microphone array like Eigenmike (see http://www.mhacoustics.com/products#eigenmikel), watermark detection in step or stage 62 can be performed by extracting directional signals, as shown in FIG. 6. Decomposition of Ambisonics coefficients is performed in step or stage 61 corresponding to the processing in step/stage 21 or step/stage 32 at watermark embedding, using for example the processing described in [9]. An example for the conversion of signals recorded by a spherical microphone array to an Ambisonics representation is described in [12].

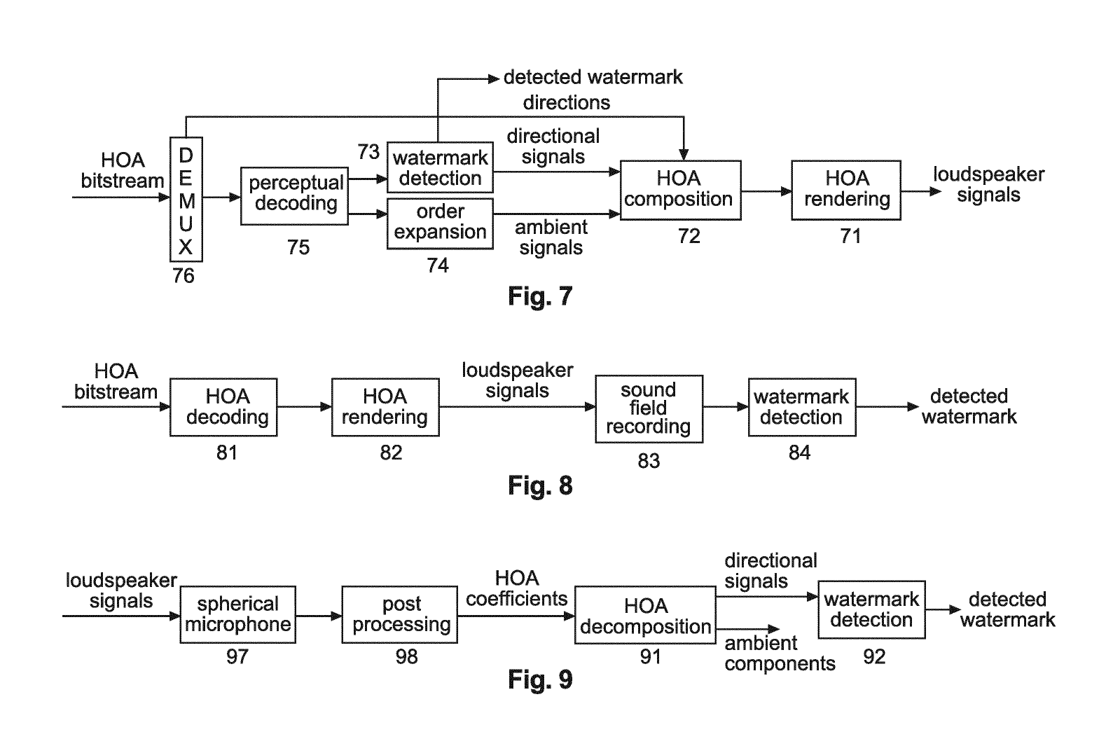

If watermark embedding had occurred within the compression framework like in FIG. 5, watermark detection can be carried out within the framework of HOA decoding in a digital transmission environment (e.g. in a set-top box) as shown in FIG. 7. The incoming HOA bitstream is split in a demultiplexer step or stage 76 into a bitstream for perceptual decoding and direction information data for directional signals of the HOA coefficients. A perceptual decoding in step or stage 75 delivers watermarked directional signals and possibly order-reduced ambient HOA components. The watermark is then detected and extracted in watermark detection step or stage 73 from the watermarked directional signals. The watermarked directional signals and the ambient HOA components (after order expansion up to N in order expansion step or stage 74) are used in HOA composition step or stage 72 together with the direction information data for recovering the HOA representation of the original sound field. The recovered HOA coefficients are used in HOA rendering step or stage 71 for rendering so as to reproduce loudspeaker signals for the original sound field.

In an alternative embodiment related to FIG. 5, step/stage 73 is omitted and the watermark detection is carried out in said perceptually decoding step/stage 75.

Alternatively, watermark detection can be carried out independent of HOA decoding, as illustrated in FIG. 8. A water-marked HOA bitstream is HOA decoded in step or stage 81 and HOA rendered in step or stage 82, resulting in corresponding loudspeaker signals. Such represented sound field can be recorded in a sound field recoding step or stage 83. The (sound field recoded) loudspeaker signals are fed to a watermark detection step or stage 84 which provides the detected watermark data.

Based on estimated directional signals, the watermark can be detected as shown in FIG. 9. A sound field reproduced by loudspeakers is recorded by an omnidirectional microphone or a microphone array like Eigenmike in a spherical microphone recording step or stage 97, followed by post-processing as required to transform the recorded microphone signal in step or stage 98 into the HOA coefficients.

In case the recording was carried out by an omnidirectional microphone, the recorded signal is used for watermark detection in step or stage 92. In that case the recorded signal is a superposition of the rendered directional signals and the ambient component. If the same watermark is embedded in the directional signals, correlation-based watermark detectors will reveal several peaks in the correlation array due to time delays from the different loudspeakers. This can be exploited for aggregating the watermark energy contained in the peaks as shown in [2].

In case the sound field is recorded by a spherical microphone array, an Ambisonics representation can be derived in step/stage 98 as shown in [12]. Directional signals can now be estimated in HOA decomposition step or stage 91 like in HOA encoding, see section HOA compression via de-composition of HOA coefficients or see [9]. Then the directional signals are passed to watermark detection step or stage 92.

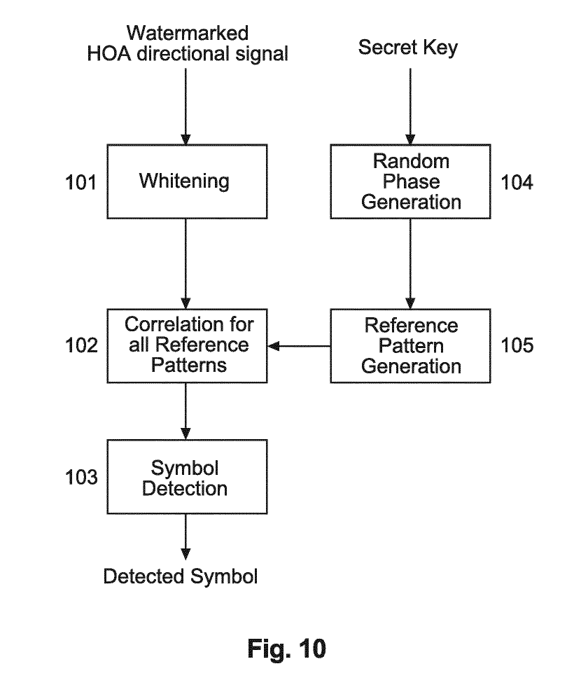

A detailed example for watermark detection is shown in FIG. 10. In the FIG. 8 processing or in the omnidirectional microphone case (first embodiment of FIG. 9), only a watermarked audio signal is available for watermark detection. In the other described cases, watermarked directional signals are available for watermark detection.

A directional signal or a watermarked directional signal passes through a whitening step or stage 101. Based on a secret key and a related watermark symbol alphabet size, the secret key is used for a random phase generation in step or stage 104 and a corresponding generation of reference patterns of e.g. 16384 samples length in step or stage 105. Candidate reference patterns from step/stage 105 are selected for cross correlations with a corresponding section of the whitened watermarked input signal in correlation step/stage 102. From the output signal of step/stage 102 the embedded watermark symbol is detected in symbol detection step or stage 103 and is output. The watermark symbol estimation based on correlation values can be performed as described in [1].

The described processing can be carried out by a single processor or electronic circuit, or by several processors or electronic circuits operating in parallel and/or operating on different parts of the complete processing.

The instructions for operating the processor or the processors according to the described processing can be stored in one or more memories. Then at least one processor is configured to carry out these instructions.

### REFERENCES

[1] M. Arnold, X. M Chen, P. G. Baum, U. Gries, G. Doërr, “A Phase-based Audio Watermarking System Robust to Acoustic Path Propagation”, IEEE Transactions On Information Forensics and Security, vol. 9, pp. 411-425, March 2014.

[2] M. Arnold, X. M. Chen, P. G. Baum; “Robust Detection of Audio Watermarks after Acoustic Path Transmission”, Proceedings of the ACM Workshop on Multimedia and Security, pp. 117-126, September 2010.

[3] J. Boehm, “Decoding for 3-D”, 130th Convention of the Audio Eng. Soc., London, UK, May 2011.

[4] M. Chapman, W. Ritsch, Th. Musil, J. Zmölnig, H. Pomberger, F. Zotter, A. Sontacchi, “A standard for interchange of ambisonic signal sets including a file standard with metadata”, Proceedings of the Ambisonics Symposium 2009, 2009.

[5] X. M. Chen, M. Arnold, P. G. Baum, G. Doërr, “AC-3 Bit Stream Watermarking”, Proceedings of IEEE International Workshop on Information Forensics and Security, pp.181-186, December 2012.

[6] Ch. Neubauer, J. Herre, “Audio watermarking of MPEG-2 AAC bit streams”, Audio Engineering Society Convention 108, 2000.

[7] R. Nishimura, “Audio watermarking using spatial masking and ambisonics”, IEEE Transactions on Audio, Speech, and Language Processing, vol. 20(9), pp. 2461-2469, November 2012.

[8] F. Zotter, “Analysis and Synthesis of Sound Radiation with Spherical Arrays”, PhD thesis, Institute of Electronic Music and Acoustics, University of Music and Performing Arts Graz, 2009.

[9] WO2013/171083 A1

[10] WO2011/117399 A1

[11] EP 2469742 A1

[12] WO2013/068283 A1

1. A method for watermarking a two-dimensional or three-dimensional Ambisonics representation of a sound field, wherein said Ambisonics representation is decomposed into directional signals and ambient components and includes estimated dominant directions, and wherein the order of said ambient components can be reduced comprising:
embedding watermark information data in said directional signals.

2. An apparatus for watermarking a two-dimensional or three-dimensional Ambisonics representation of a sound field, said apparatus being adapted to:
decomposing said Ambisonics representation into directional signals and ambient components and estimated dominant directions, wherein the order of said ambient components can be reduced
embedding watermark information data in said directional signals.

3. The apparatus according to claim 2, wherein the watermarked directional signals and the possibly order reduced ambient components are perceptually encoded.

4. The apparatus according to claim 2, wherein the method further comprises embedding different watermark information data into individual directional signals.

5. The apparatus according to claim 2, wherein the method further comprises embedding the same watermark information data into individual directional signals.

6. The apparatus according to claim 2, wherein for each directional signal to be watermarked an individual masking curve is used to constrain the watermark embedding strength.

7. The apparatus according to claim 2, wherein a watermark payload is protected by error correction and each watermark symbol corresponds to a reference pattern in said water-mark information data embedding.

8. A method for regaining watermark information data which were embedded in a two-dimensional or three-dimensional Ambisonics representation of a sound field according to the method of claim 1, including:
decomposing said watermarked Ambisonics representation into said directional signals, said estimated dominant directions and said ambient components;
performing a watermark detection in said watermarked directional signals.

9. An apparatus for regaining watermark information data which were embedded in a two-dimensional or three-dimensional Ambisonics representation of a sound field according to the method of claim 1, said apparatus being adapted to:
decompose said watermarked Ambisonics representation into said directional signals, said estimated dominant directions and said ambient components;
perform a watermark detection in said watermarked directional signals.

10. The method for regaining watermark information data which were embedded in a two-dimensional or three-dimensional Ambisonics representation of a sound field according to the method of claim 3, including:
demultiplexing said estimated dominant directions from said watermarked Ambisonics representation;
perceptually decoding said perceptually encoded directional signals and said possibly order-reduced ambient components;
performing a watermark detection in said watermarked directional signals;
if the order of said ambient components was reduced, correspondingly expanding said order-reduced ambient components;
composing said ambient components and said directional signals using said estimated dominant directions.

11. An apparatus for regaining watermark information data which were embedded in a two-dimensional or three-dimensional Ambisonics representation of a sound field according to the apparatus of claim 3, said apparatus being adapted to:
demultiplex said estimated dominant directions from said watermarked Ambisonics representation;
perceptually decode said perceptually encoded directional signals and said possibly order-reduced ambient components;
perform a watermark detection in said watermarked directional signals;
if the order of said ambient components was reduced, correspondingly expand said order-reduced ambient components;
compose said ambient components and said directional signals using said estimated dominant directions.

12. (canceled)

13. A method for regaining from sound field loudspeaker signals watermark information data which were embedded in a two-dimensional or three-dimensional Ambisonics representation of said sound field, said method including:
capturing said loudspeaker signals using a spherical microphone;
generating HOA coefficients from the signals of said spherical microphone;
decomposing said HOA coefficients into directional signals and ambient components;
performing a watermark detection in said directional signals.

14. (canceled)

15. A non-transitory storage medium, for example an optical disc or a pre-recorded memory, that contains or stores, or has recorded on it, a digital audio signal encoded according to the method of claim 1.

16. (canceled)

17. A non-transitory program storage device, readable by a computer, tangibly embodying a program of instructions executable by the computer, to perform a method for watermarking a two-dimensional or three-dimensional Ambisonics representation of a sound field, wherein said Ambisonics representation is decomposed into directional signals and ambient components and includes estimated dominant directions, and wherein the order of said ambient components can be reduced, comprising:
embedding watermark information data in said directional signals.

18. The method according to claim 1, wherein the watermarked directional signals and the possibly order reduced ambient components are perceptually encoded.

19. The method according to claim 1, wherein the method further comprises embedding different watermark information data into individual directional signals.

20. The method according to claim 1, wherein the method further comprises embedding the same watermark information data into individual directional signals.

21. The method according to claim 1, wherein for each directional signal to be watermarked an individual masking curve is used to constrain the watermark embedding strength.

22. The method according to claim 1, wherein a watermark payload is protected by error correction and each watermark symbol corresponds to a reference pattern in said water-mark information data embedding.
